(19) United States
(12) Patent Application Publication
(10) Pub. No.: US 2019/0372408 A1
(43) Pub. Date: Dec. 5, 2019

(54) ROTATING ELECTRIC MACHINE

(71) Applicant: DENSO CORPORATION, Kariya-city (JP)

(72) Inventors: Makoto TANIGUCHI, Kariya-city (JP); Akira FUKUSHIMA, Kariya-city (JP)

(73) Assignee: DENSO CORPORATION, Kariya-city (JP)

(21) Appl. No.: 16/537,754

(22) Filed: Aug. 12, 2019

Related U.S. Application Data
(63) Continuation of application No. PCT/JP2018/004490, filed on Feb. 8, 2018.

(30) Foreign Application Priority Data
Feb. 13, 2017 (JP) 2017-024437

(51) Int. Cl. H02K 1/16; H02K 1/27; H02K 16/02; H02K 16/04

(52) U.S. Cl. CPC H02K 1/165; H02K 1/278; H02K 16/04; H02K 16/02; H02K 1/2786

(57) ABSTRACT

A rotating electric machine comprises a rotor having a plurality of magnetic pole parts in a peripheral direction, and at least one stator arranged coaxially with the rotor and on at least one of an outer peripheral side and an inner peripheral side of the magnetic pole parts. The stator comprises a stator core having a plurality of slots in the peripheral direction, and a stator winding wound around the slots. The stator core comprises an annular yoke and a plurality of teeth extending in a radial direction from the yoke toward the magnetic pole parts, and the teeth are configured such that their width in the peripheral direction becomes narrower and their thickness in an axial direction becomes thicker toward a radially inner side from a radially outer side.

### CROSS-REFERENCE TO RELATED APPLICATION

This application is a bypass application of International Application No. PCT/JP2018/004490 filed Feb. 8, 2018 which designated the U.S. and claims priority to Japanese Patent Application No. 2017-024437 filed Feb. 13, 2017, the contents of which are incorporated herein by reference.

### TECHNICAL FIELD

The present disclosure relates to a rotating electric machine of the radial-gap type.

### BACKGROUND

A rotating electric machine may employ a rectangular wire as a conductor for a stator winding in order to reduce its size. The cross-sectional shape of a rectangular wire is preferably square or rectangular rather than trapezoidal because the wire processing process can be simplified.

### SUMMARY

In a rotating electric machine according to an aspect, the rotating electric machine includes a rotor having a plurality of magnetic pole parts in a peripheral direction, and at least one stator arranged coaxially with the rotor and on at least one of an outer peripheral side and an inner peripheral side of the magnetic pole parts.

The stator includes a stator core having a plurality of slots in the peripheral direction, and a stator winding wound around the slots, the stator core includes an annular yoke and a plurality of teeth extending in a radial direction from the yoke toward the magnetic pole parts, the stator winding having a configuration in which a plurality of conductors in the slots separated by one magnetic pole are connected by connection parts, and the teeth being configured such that their width in the peripheral direction becomes narrower and their thickness in an axial direction becomes thicker toward a radially inner side from a radially outer side.

### BRIEF DESCRIPTION OF THE DRAWINGS

The above and other objects, features, and advantages of the present disclosure will become clearer from the following detailed description with reference to the accompanying drawings. In the accompanying drawings,

FIG. 1 is an axial cross-sectional view of a rotating electric machine;

FIG. 2 is a radial cross-sectional view showing a rotor and a stator core;

FIG. 3 is a perspective view showing the configuration of a conductor segment;

FIG. 4 is a partial cross-sectional view of a stator;

FIG. 5 is an enlarged perspective view showing the conductors in the state in which they are joined with each other at a coil end part;

FIG. 6A is a plan view of the teeth, and FIG. 6B is an axial cross-sectional view of the teeth;

FIG. 7 is a perspective view showing the three-dimensional shape of the teeth;

FIG. 8 is an axial cross-sectional view of a rotor and a stator;

FIG. 9A is a radial cross-sectional view showing a rotor and a stator core, and FIG. 9B is an axial cross-sectional view of the main part of a rotating electric machine according to the second embodiment;

FIG. 10 is a perspective view showing the three-dimensional shape of the teeth according to the second embodiment;

FIG. 11A is a radial cross-sectional view showing rotors and a stator core, and FIG. 11B is an axial cross-sectional view of the main part of a rotating electric machine according to the third embodiment;

FIG. 12 is a perspective view showing the three-dimensional shape of the teeth according to the third embodiment;

FIG. 13A is a radial cross-sectional view showing a rotor and stator cores, and FIG. 13B is an axial cross-sectional view of the main part of a rotating electric machine according to the fourth embodiment;

FIG. 14 is a radial cross-sectional view showing a rotor and a stator core according to another embodiment;

FIG. 15 is a radial cross-sectional view showing a rotor and stator cores according to another embodiment; and

FIGS. 16A and 16B are axial cross-sectional views of a tooth according to another embodiment.

### DETAILED DESCRIPTION OF THE PREFERRED EMBODIMENTS

Since the cross-sectional shape of the conductor is square or rectangular, it is desirable that the stator of the rotating electric machine of the radial gap type has a stator core (iron core) provided with a rectangular slot for accommodating the conductor. In this case, the teeth provided peripherally on the stator core may have a trapezoidal shape of which the width narrows toward the inner diameter side, and magnetic saturation is likely to occur at the inner diameter side where the width of the magnetic path is narrow. When magnetic saturation occurs in the rotating electrical machine, the excitation current increases, and this may cause problems such as a decrease in efficiency, a decrease in output, and an increase in noise and vibration. In order to prevent magnetic saturation from occurring, it is conceivable to widen the inner peripheral part of each tooth while maintaining the above-described trapezoidal shape. However, such configuration is a trade-off with an increase in the size of the stator itself.

For example, the technique described in WO 2014/192350 A configures the teeth such that their peripheral width is substantially constant along the radial direction so that the peripheral width of the slot on the inner peripheral side is smaller than its peripheral width on the outer peripheral side. In this case, for example, a configuration in which the slot has a trapezoidal shape is shown.

However, in the configuration of WO 2014/192350 A, since the width of the slot differs in the radial direction, the manner of accommodating the conductor in the slot needs to be changed between the inner circumference side and the outer circumference side. For example, the direction of conductor accommodation in the slot may need to be changed between the inner circumference side and the outer circumference side, or it may be necessary to use conductors with different cross-sectional shapes. This may cause problems in the process of manufacturing the rotor; for example, the step of inserting the conductor into the slot may become complicated, and different forming jig may be required and management and setup may become more troublesome. In other words, there is a concern that the configuration may become complicated.

The present disclosure has been made in view of the above-described problems, and a main purpose thereof is to provide a rotating electric machine intended to increase output but capable of suppressing the configuration from being complicated.

Aspects for solving the above-mentioned problems and the effects thereof will be described below.

The first aspect includes:

a rotor having a plurality of magnetic pole parts in a peripheral direction, and

at least one stator arranged coaxially with the rotor and on at least one of an outer peripheral side and an inner peripheral side of the magnetic pole parts, wherein

the stator includes a stator core having a plurality of slots in the peripheral direction, and a stator winding wound around the slots,

the stator core includes an annular yoke and a plurality of teeth extending in a radial direction from the yoke toward the magnetic pole parts,

the stator winding has a configuration in which a plurality of conductors in the slots separated by one magnetic pole are connected by connection parts, and

the teeth are configured such that their width in the peripheral direction becomes narrower and their thickness in an axial direction becomes thicker toward a radially inner side from a radially outer side.

In the above configuration, the teeth of the stator core are configured such that their width in the peripheral direction becomes narrower toward the radially inner side from a radially outer side, and in a plan view of the stator core (that is, as viewed from the side of one of its axial ends), they have a trapezoidal shape. Thus, the slots can be formed between teeth adjacent in the peripheral direction so as to have a uniform width in the radial direction. Therefore, it is possible to suppress disadvantages, such as the need to change the manner of accommodating the conductor in the slots between the inner peripheral side and the outer peripheral side, from occurring.

In addition, the teeth are configured such that their thickness in the axial direction becomes thicker toward the radially inner side. In this case, although the peripheral width of the teeth narrows toward the radially inner side, since the axial thickness increases correspondingly, it is possible to secure the area for the magnetic flux path at the inner peripheral part of the teeth. Therefore, magnetic saturation in the teeth can be alleviated without increasing the device size. As a result, it is possible to increase the output without making the configuration complicated.

According to the second aspect, at at least one of the two axial ends of the stator core, an end face of a part corresponding to the teeth is inclined with respect to a direction orthogonal to the axial direction, and forms an inclined face that gradually bulges outward in the axial direction toward the radially inner side.

In the above configuration, since the end face of at least one of the ends of the stator core in the axial direction forms an inclined face that is inclined with respect to the direction orthogonal to the axial direction and bulges outward in the axial direction toward the radially inner side, it is possible to suitably form a stator core that has teeth of which peripheral width decreases and axial thickness increases toward the radially inner side.

According to the third aspect, each tooth is configured such that, at its partition part partitioning the slots in the peripheral direction, the cross-sectional area of the inner peripheral side end and the cross-sectional area of the outer peripheral side end are the same.

In this case, since the cross-sectional area of the inner peripheral side end and the cross-sectional area of the outer peripheral side end are the same at the partition part of each tooth partitioning the slots in the peripheral direction, magnetic saturation is less likely to occur at the inner peripheral side, where magnetic saturation tends to occur in the prior art, and the amount of flux linkage to the stator winding can be enhanced. This makes it possible to increase the output.

According to the fourth aspect, a peripheral side face of the teeth is a straight flat face, and, at at least one of two axial ends of the stator core, an end face of a part corresponding to the teeth is inclined with respect to a direction orthogonal to the axial direction, and forms an inclined face that gradually bulges outward in the axial direction toward the radially inner side, and the inclined face is an arc face extending in a concave shape in the radial direction.

In the above configuration, since the inclined faces are arc faces extending in a concave shape in the radial direction, as compared with the configuration in which the inclined faces extend linearly in the radial direction (the configuration with a conical shape), it is possible to reduce the difference in the cross-sectional area of the tooth at each part in the radial direction. That is, when the area S of the radial cross section of the teeth is represented as “peripheral width D×(multiplied by) axial thickness H”, by making the peripheral width D change proportionally in the radial direction and the axial thickness H change in an inverse proportional manner, it is possible to make the cross-sectional area of each tooth substantially the same at each part in the radial direction. As a result, the amount of magnetic flux can be made uniform in the radial direction of the teeth.

According to the fifth aspect, the stator core includes a laminated core part formed by laminating a plurality of steel plates, and at least one inclined core part integrally provided on at least one of two axial ends of the laminated core part and configured to convert an axial end face of the stator core to an inclined face inclined with respect to a direction orthogonal to the axial direction and gradually bulging outward in the axial direction toward the radially inner side.

In the above configuration, the stator core is formed by integrally providing the inclined core part on the laminated core part formed by laminating steel plates. In this case, it is possible to advantageously construct the stator core having a desired shape in the axial direction using the laminated core part having the same configuration as those of the prior art.

According to the sixth aspect, the inclined core part is formed of a compact made of magnetic powder.

By forming the inclined core part with magnetic powder as a material, the stator core can be easily realized even when the stator core should be configured to have an inclined end face in the axial direction.

According to the seventh aspect, the inclined core part is provided over an area of the axial end face of the stator core excluding at least a part of the yoke.

A known rotating electric machine is configured to fix the stator core by engaging the yoke with the housing. In this case, when the inclined core part formed of a magnetic powder compact is provided on the axial end face of the core, there may be a problem in fixing the core. Regarding this, in the above-described configuration, since the inclined core part is provided over an area of the axial end face of the stator core excluding at least a part of the yoke, the stator core can be appropriately fixed even though the inclined core part is provided on the core end face.

According to the eighth aspect, the conductors forming the stator winding are arranged in the radial direction in the slots, at both axial ends of the stator core, the connection parts form coil end parts, the connection parts being a part of the stator winding connecting the stator winding between the slots separated by at least a distance of one magnetic pole, at at least one of the two axial ends of the stator core, an end face of a part corresponding to the teeth is inclined with respect to a direction orthogonal to the axial direction, and forms an inclined face that gradually bulges outward in the axial direction toward the radially inner side, and at the coil end parts, the connection parts located on the radially inner side of the slots form a shape that is more raised than the connection parts located on the radially outer side of the slots.

Since the peripheral length of the stator core is different between the radially inner side and the radially outer side, if the conductor lengths of the connection parts (for example, the lengths of the turn parts of the conductor segments) of the stator winding are all the same, the degree of raising of the connection parts at the coil end parts differs between the radially inner side and the radially outer side. That is, the connecting parts located at the radially inner side of the slots form a shape more raised than the connection parts located at the radially outer side of the slots. In this case, the inclined face of the end face of the stator core in the axial direction is oriented in the same direction as the raising at the coil end part. This enables efficient space utilization at the axial end face(s) of the stator core.

According to the ninth aspect, the rotor includes, as the magnetic pole parts, first magnetic pole parts disposed on the inner peripheral side of the stator, and second magnetic pole parts disposed on the outer peripheral side of the stator, the stator core includes, as the teeth, first teeth extending radially inward from the yoke toward the first magnetic pole parts, and second teeth extending radially outward from the yoke toward the second magnetic pole parts, and the first teeth and the second teeth are configured such that their width in the peripheral direction becomes narrower and their thickness in the axial direction becomes thicker toward the radially inner side from the radially outer side.

In the above configuration of a rotating electric machine of the double rotor type, the first teeth and second teeth are configured such that their width in the peripheral direction becomes narrower and their thickness in the axial direction becomes thicker toward the radially inner side from the radially outer side. In this case, as with the case described earlier, there is no need to change the manner of accommodating the conductor in the slots between the inner peripheral side and the outer peripheral side, and magnetic saturation at the teeth can be alleviated without increasing the device size.

According to the tenth aspect, the rotating electric machine comprises, as the stator, a first stator and a second stator placed on the radially inner side and the radially outer side, respectively, with a gap between them, the rotor provided between the first stator and the second stator comprises, as the magnetic pole parts, first magnetic pole parts disposed on the inner peripheral side, and second magnetic pole parts disposed on the outer peripheral side, one of the stator cores provided respectively in the first stator and the second stator comprises, as the teeth, first teeth extending radially outward from the yoke toward the first magnetic pole parts, and second teeth extending radially inward from the yoke toward the second magnetic pole parts, and the first teeth and the second teeth are configured such that their width in the peripheral direction becomes narrower and their thickness in the axial direction becomes thicker toward the radially inner side from the radially outer side.

In the above configuration of a rotating electric machine of the double stator type, the first teeth and second teeth are configured such that their width in the peripheral direction becomes narrower and their thickness in the axial direction becomes thicker toward the radially inner side from the radially outer side. In this case, as with the case described earlier, there is no need to change the manner of accommodating the conductor in the slots between the inner peripheral side and the outer peripheral side, and magnetic saturation at the teeth can be alleviated without increasing the device size.

According to the eleventh aspect, at at least one of two ends of the stator in the axial direction, end faces of parts corresponding to the first teeth and the second teeth are inclined faces inclined with respect to a plane orthogonal to the axial direction, and inclination angles of the inclined faces are different between the first teeth side and the second teeth side.

In this case, in the configuration in which the inclination angles of the inclined faces (the end faces of the stator core in the axial direction) differ between the first teeth side and the second teeth side, it is possible to make the cross-sectional areas of the teeth on the inner peripheral side and the outer peripheral side of the slots the same even if the radial lengths or the peripheral widths of the first teeth and the second teeth differ from each other.

According to the twelfth aspect, the number of the first teeth is different from the number of the second teeth.

In this case, since the number of the first teeth and the number of second teeth are different, it is possible to adopt different winding schemes of the stator winding for the radially inner side (first teeth side) and the radially outer side (second teeth side). For example, the number of the first teeth on the radially inner side may be smaller than the number of the second teeth.

Embodiments will be described below with reference to the drawings. The rotating electric machine according to the present embodiment is, for example, used as a vehicle power source. However, the rotating electric machine can be widely used for industrial purpose, for vehicles, for home appliances, for office automation equipment, for game machines, and so on. The same or equivalent parts in the embodiments described below are assigned with the same reference number in the drawings, and an earlier explanation should be referred to regarding those parts having the same reference number as another.

### First Embodiment

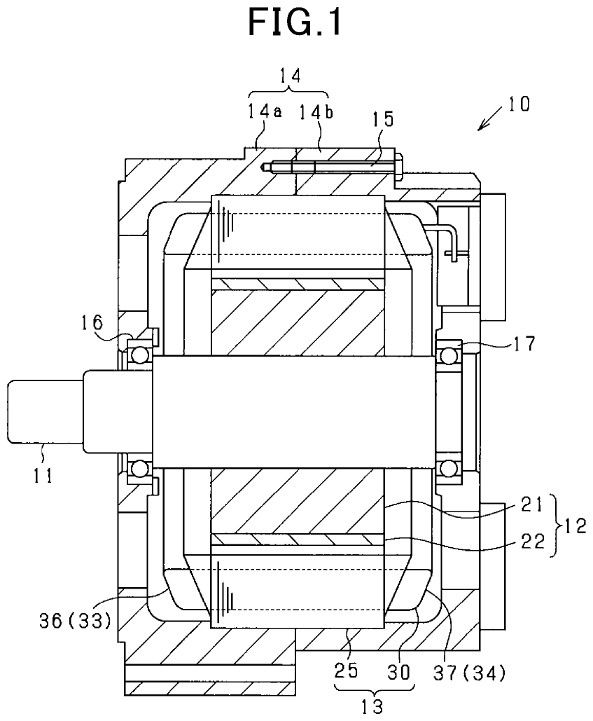

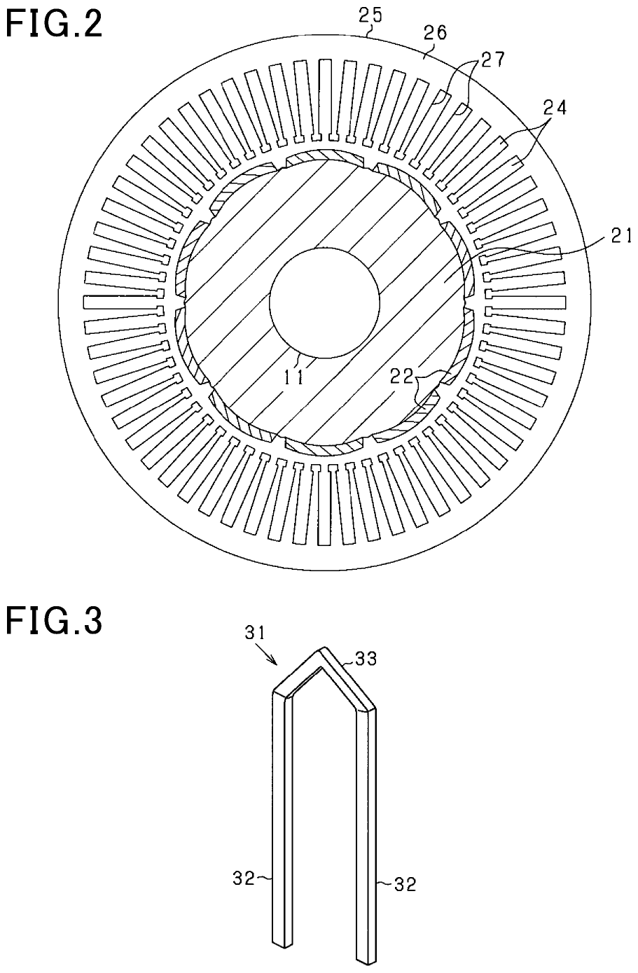

A rotating electric machine 10 according to the present embodiment is a polyphase AC motor of the inner rotor type (internal rotation type), and it is schematically illustrated in FIGS. 1 and 2. FIG. 1 is an axial cross-sectional view in the direction along the rotation shaft 11 of the rotating electric machine 10, and FIG. 2 is a radial cross-sectional view of a rotor 12 and a stator 13 in the direction perpendicular to the rotation shaft 11. In the following description, the direction in which the rotation shaft 11 extends is referred to as the axial direction, the direction extending radially around the rotation shaft 11 is referred to as the radial direction, and the direction extending peripherally around the rotation shaft 11 is referred to as the peripheral direction.

The rotating electric machine 10 comprises the rotor 12 fixed to the rotation shaft 11, the stator 13 provided so as to surround the rotor 12, and a housing 14 accommodating the rotor 12 and the stator 13. The rotor 12 and the stator 13 are coaxially arranged. The housing 14 comprises a pair of bottomed cylindrical housing members 14a and 14b, and the housing members 14a and 14b are integrated by fastening a bolt 15 in a state where their openings are joined with each other. The housing 14 is provided with bearings 16 and 17, and the rotation shaft 11 and the rotor 12 are rotatably supported by the bearings 16 and 17.

The rotor 12 has a rotor core 21 and a plurality of permanent magnets 22 disposed on the outer circumference of the rotor core 21 (that is, the side facing the inner circumference of the stator 13 in the radial direction). The rotor core 21 is formed by laminating a plurality of electromagnetic steel plates in the axial direction and fixing them by caulking or the like. The permanent magnets 22 correspond to the magnetic pole parts, and they are arranged at certain intervals in the peripheral direction such that the polarities are alternately different. In the present embodiment, the number of the magnetic poles of the rotor 12 is ten, but the number of the magnetic poles is not limited to this. The permanent magnets 22 may be rare earth magnets or ferrite magnets, and they may have a form having an arc-shaped or a V-shaped cross section instead of a rectangular cross section. Further, instead of the embedded magnet type, they may be a surface magnet type and the permanent magnets 22 may be disposed on the magnetic pole surface.

The stator 13 includes an annular stator core 25 having a plurality of slots 24 in the peripheral direction, and a three-phase (U-phase, V-phase, W-phase) stator winding 30 wound around the slots 24 of the stator core 25 by distributed winding (the stator winding 30 is omitted in FIG. 2). The stator core 25 is formed by laminating a plurality of annular electromagnetic steel plates in the axial direction and fixing them by caulking or the like. The stator core 25 comprises an annular yoke 26 and teeth 27 protruding inward in the radial direction from the yoke 26 and arranged at certain intervals in the peripheral direction, and the slots 24 are formed between adjacent teeth 27. The teeth 27 are provided at equal intervals in the peripheral direction. The opening of each slot 24 extends in the radial direction of the stator core 25.

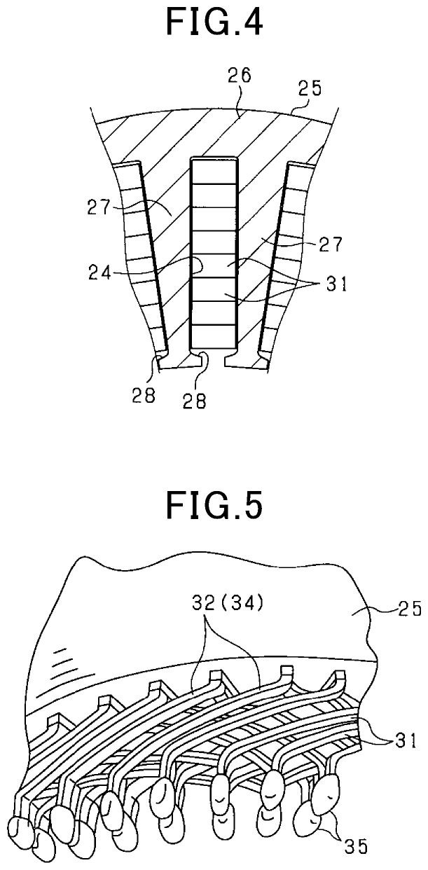

A flange 28 is formed at the tip of each tooth 27 (see FIG. 4), and this flange 28 corresponds to the ridge part extending in the peripheral direction. In FIG. 2 and other drawings, semi-closed slots are shown as the slots 24 formed with the flanges 28 at the tips of the teeth 27, but they may be open slots not formed with the flanges 28.

The number of slots 24 formed in the stator core 25 is two per one phase of the stator winding 30 with respect to the number of magnetic poles of the rotor 12 (10 magnetic poles). In the present embodiment, the number of slots is 10×3×2=60. The 60 slots 24 consists of U-phase slots, V-phase slots, and W-phase slots arranged two by two repeatedly in the peripheral direction.

The stator winding 30 is wound around each slot 24 by winding it around each tooth 27. In the present embodiment, the stator winding 30 is configured by joining a plurality of conductor segments 31 to each other, and the conductor segments 31 are shown in FIG. 3. The conductor segment 31 includes a pair of straight parts 32 and a turn part 33 connecting one end of one straight part 32 with one end of the other straight part 32. The distance between the pair of straight parts 32 is one magnetic pole pitch (pitch of six slots). The length of the pair of straight parts 32 is greater than the thickness of the stator core 25 in the axial direction. The conductor segments 31 are formed using a coated wire (rectangular wire) made of a linear material having a rectangular cross section, and they are prepared by plastically deforming it into a generally U-shape. The cross section of the conductor segments 31 may be either square or rectangular, and the corners may be rounded or chamfered. As shown in FIG. 4, a plurality of (eight) conductor segments 40 are inserted in each slot 24 such that they are arranged in a row in the core radial direction. The conductor segments 31 are inserted in the slots 24 in such a state that they are surrounded by an insulating sheet.

The turn part 33 of each conductor segment 31 protrudes at one end of the stator core 25 in the axial direction, and the tips of the pair of straight parts 32 protrude at the other end. Further, in this state, as shown in FIG. 5, the straight parts 32 are respectively twisted obliquely with respect to the end face of the stator core 25 in peripherally opposite directions to form twisted parts 34, and the tips of two conductor segments 31 are joined together by, for example, welding at the twisted parts 34. The conductor junctions of the conductor segments 31 are covered by an insulator 35. Thus, the conductor segments 31 are electrically connected in a certain pattern. In this case, The U-phase winding, V-phase winding, and W-phase winding are wound around the stator core 25 in the peripheral direction by certain conductor segments 31 in series, and the phase windings form the stator winding 30.

In the state where the stator winding 30 is wound around the stator core 25, a ring-like first coil end part 36 is formed by the turn parts 33 of the conductor segments 31 as a whole at one end of the stator core 25 in the axial direction (see FIG. 1). Further, at the other end of the stator core 25 in the axial direction, a ring-like second coil end part 37 (see FIG. 1) is formed by the straight parts 32 (twisted parts 34) of the conductor segments 31. At the coil end parts 36 and 37, the turn parts 33 and the twisted parts 34 correspond to the connection parts each connecting two slots 24 separated by one magnetic pole (may also be separated by two magnetic poles).

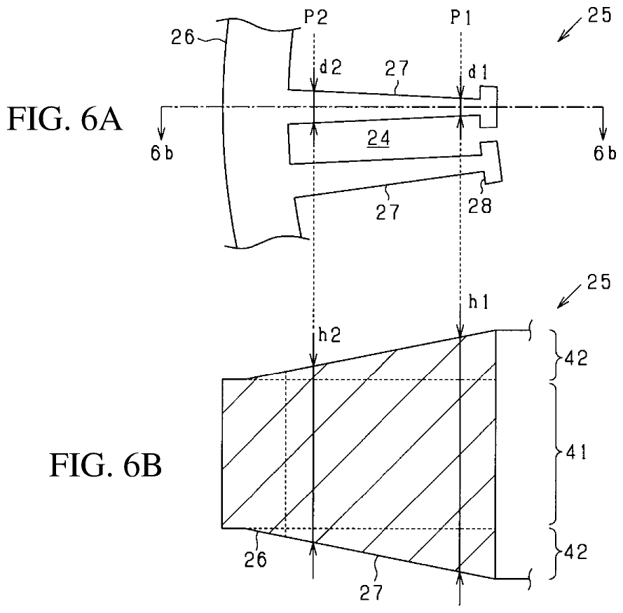

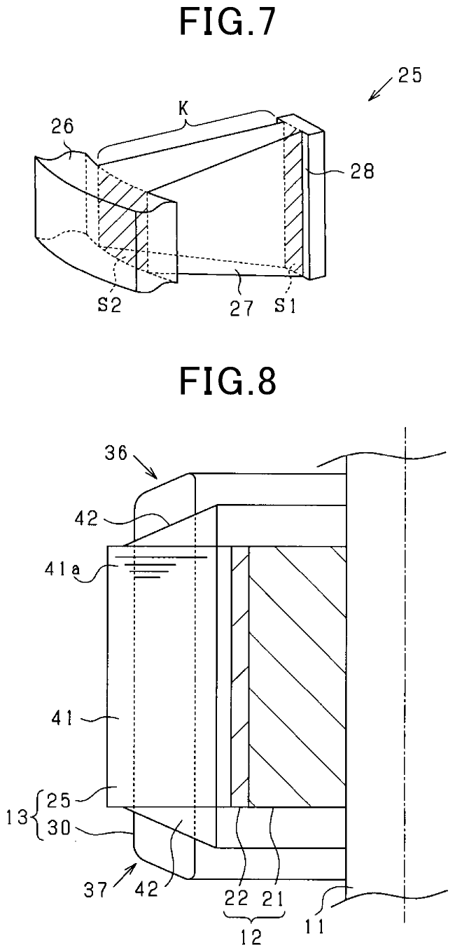

Next, the characteristic configuration of the teeth 27 of the stator core 25 will be described. In FIGS. 6A and 6B, FIG. 6A shows the planar shape of the teeth 27, and FIG. 6B shows an axial cross section of the teeth 27. FIG. 6B is a cross-sectional view taken along the line 6b-6b of FIG. 6A. FIG. 7 is a perspective view showing the three-dimensional shape of the teeth 27.

As shown in FIG. 6A, the width of the teeth 27 of the stator core 25 in the peripheral direction is smaller at the radially inner side than at the radially outer side, and the peripheral width dl at the radially inner position P1 is smaller than the peripheral width d2 at the radially outer position P2 (d1<d2). In this case, each tooth 27 have a trapezoidal shape as seen in a plan view of the stator core 25 (that is, as viewed from the end side in the axial direction). Thus, the slots 24 are formed between teeth 27 adjacent in the peripheral direction so as to have a uniform width in the radial direction.

Further, as shown in FIG. 6B, the thickness of the teeth 27 in the axial direction is larger at the radially inner side than at the radially outer side, and the radial thickness h1 at the radially inner position P1 is larger than the axial thickness h2 at the radially outer position P2 (h1>h2). In this case, the end faces of the stator core 25 in the axial direction are inclined with respect to the direction orthogonal to the axial direction, and they form inclined faces that gradually bulge outward in the axial direction toward the radially inner side. In the present embodiment, the inclined faces of the core end faces are configured to extend linearly in the radial direction. Note that, although the stator core 25 comprises the yoke 26 which is the outer peripheral part and the teeth 27 provided peripherally on the inner side thereof, it suffices if the end faces of the part corresponding to the teeth 27 are inclined faces.

Here, it is desirable that each tooth 27 is configured such that, at its partition part partitioning the slots 24 in the peripheral direction, the cross-sectional area of the inner peripheral side end and the cross-sectional area of the outer peripheral side end are the same. That is, as shown in FIG. 7, the part of the tooth 27 excluding the flange 28 is the partition part K partitioning the slots 24 in the peripheral direction, and the cross-sectional area S1 of the inner peripheral side end of the partition part K and the cross-sectional area S2 of the outer peripheral side end thereof are the same (S1=S2). The cross-sectional areas S1 and S2 may be determined by the product of the peripheral width and axial thickness of the teeth 27.

The peripheral width of the teeth 27 narrows toward the radially inner side, which is the rotor 12 side, but since the axial thickness increases correspondingly, it is possible to secure the area for the magnetic flux path at the inner peripheral part of the teeth 27.

As shown in FIG. 8, the stator core 25 comprises a laminated core part 41 formed by laminating steel plates 41a, and inclined core parts 42 integrally provided on both of the axial ends of the laminated core part 41. The laminated core part 41 has an annular shape, and both of its end faces in the axial direction are flat and orthogonal to the axial direction.

The inclined core parts 42 are integrally provided on the end faces of the laminated core part 41, and they have an umbrella-like shape that bulges toward the radial center at the side opposite to the laminated core part 41. Thus, the end faces of the stator core 25 in the axial direction are inclined with respect to the direction orthogonal to the axial direction, and they form inclined faces (conical faces) that gradually bulge outward in the axial direction toward the radially inner side. The inclined core parts 42 are formed of a compact of magnetic powder. For example. the magnetic powder is formed of particles of an iron-silicon based alloy, which is a soft magnetic material, covered with an insulating layer. Upon manufacturing the stator core 25, for example, the inclined core parts 42 may be individually formed and assembled to the laminated core part 41 with an epoxy-based adhesive or the like. Alternatively, the inclined core parts 42 may be formed integrally with the laminated core part 41 by attaching a mold to the laminated core part 41, introducing magnetic powder into the mold, and then performing compression molding.

The laminated core part 41 and the inclined core parts 42 have generally the same shape in a plan view, and they each have a part corresponding to the yoke 26 (yoke forming part) and a part corresponding to the teeth 27 (teeth forming part). However, in the present embodiment, the inclined core part 42 is provided on the axial end face of the stator core 25 over an area excluding a part of the yoke 26. Specifically, the outer peripheral dimension of the inclined core part 42 is smaller than the outer peripheral dimension of the laminated core part 41, and the inclined core part 42 does not exist at a part of the end face of the laminated core part 41. In this case, the part of the end face of the laminated core part 41 at which the inclined core part 42 is not provided is used to fix the stator core 25 by engaging the stator core 25 with the housing 14. Note that the outer peripheral dimension of the inclined core part 42 may be the same as the outer peripheral dimension of the laminated core part 41.

As viewed in the axial direction, the laminated core part 41 of the stator core 25 has the same size as the rotor 12. That is, the stator core 25 is configured such that, among the laminated core part 41 and the inclined core parts 42, the laminated core part 41 faces the outer peripheral part of the rotor 12. However, the stator core 25 may be configured such that the inclined core parts 42 face the outer peripheral part of the rotor 12.

According to the rotating electric machine 10 configured as described above, since the cross-sectional area S1 of the inner peripheral side end of the tooth 27 is equal to the cross-sectional area S2 of the outer peripheral side end thereof, the narrowest part on the inner peripheral side, at which magnetic saturation tends to occur in the prior art, no longer suffers from magnetic saturation, and the flux linkage to the stator winding 30 can be enhanced. In this case, in the configuration in which the rotor 12 faces the laminated core part 41 of the stator core 25, the field flux of the rotor 12 enters the laminated core part 41 of the stator core 25 and then spreads to the inclined core part 42 in the axial direction. At this time, since the inclined core part 42 is formed of magnetic powder, the magnetic flux density of the laminated core part 41 is reduced, but field flux is supplied from the rotor 12 to compensate for the reduced amount and the flux linkage is enhanced. Since the inclined core part 42 is formed of magnetic powder, the flow of magnetic flux has no directionality, and it spreads easily in the axial direction if there is a magnetic potential difference. In addition, since the magnetic flux density is low at the outer peripheral side of the teeth 27 (that is, the side with large width) in the first place, magnetic saturation does not occur even if the flux linkage is enhanced.

Here, since the peripheral length of the stator core 25 is different between the radially inner side and the radially outer side, if the conductor lengths of the turn part 33 and the twisted part 34 of the conductor segment 31 of the stator winding 30 are all the same, the degree of raising of the turn part 33 and the twisted part 34 at the coil end parts 36 and 37 differs between the radially inner side and the radially outer side. Therefore, as shown in FIG. 8, at each of the coil end parts 36 and 37, the turn part 33 and the twisted part 34 located on the radially inner side (core center side) of the slot 24 have a form more raised than the turn part 33 and the twisted part 34 located on the radially outer side of the slot 24. In this case, the inclined faces of the end face of the stator core 25 in the axial direction are oriented in the same direction as the raisings at the coil end parts 36 and 37. This enables efficient space utilization at the axial end faces of the stator core 25.

In addition, it is also possible to form the stator winding 30 using a molded copper wire (one continuous wire) instead of the conductor segments 31. In such a case, when the molded copper wire is bent at an equal pitch, again, it forms a shape that is raised near the center of the stator winding 30, and efficient space utilization is possible as described above in such a winding structure. If the configuration allows for the raising near the center of the stator winding 30, it is possible to use only one type of copper wire mold in the manufacturing, which is economically advantageous.

According to the embodiment described above, the following advantageous effects can be obtained.

In the stator core 25, the teeth 27 are configured such that their width in the peripheral direction becomes narrower and their thickness in the axial direction becomes thicker toward the radially inner side from the radially outer side. In this case, since the peripheral width of the teeth 27 becomes narrower toward the radially inner side from the radially outer side, the slots 24 can be formed between peripherally adjacent teeth 27 so as to have a uniform width in the radial direction. Thus, it is possible to suppress disadvantages such as the need to change the manner of accommodating the conductor (the stator winding 30) in the slots 24 between the inner peripheral side and the outer peripheral side.

In addition, since the thickness of the teeth 27 in the axial direction becomes thicker toward the radially inner side, even though their peripheral width becomes narrower toward the radially inner side, an area for the magnetic flux path can be secured at the inner peripheral part of the teeth 27. Therefore, the magnetic saturation in the teeth 27 can be alleviated without increasing the device size. As a result, it is possible to increase the output without making the configuration complicated.

The end faces of the stator core 25 in the axial direction are inclined with respect to the direction orthogonal to the axial direction, and they form inclined faces that gradually bulge outward in the axial direction toward the radially inner side (center side). In this case, it is possible to advantageously form the stator core 25 having the teeth 27 with a peripheral width that narrows and an axial thickness that increases as it approaches the radially inner side.

The teeth 27 are configured in such a manner that the cross-sectional area of their inner peripheral side end (S1 in FIG. 7) is equal to the cross-sectional area of their outer peripheral side end (S2 in FIG. 7). As a result, magnetic saturation is less likely to occur at the inner peripheral side end, where magnetic saturation tends to occur in the prior art, and the flux linkage to the stator winding 30 can be enhanced. This makes it possible to increase the output.

According to the inventors' estimation, a torque increase of about 10% can be expected by the enhancement of the flux linkage. Further, the reduction of the magnetic saturation also contributes to the reduction of noise due to the vibration of the stator core 25.

The stator core 25 comprises a laminated core part 41 formed by laminating steel plates, and inclined core parts 42 provided integrally on the end parts of the laminated core part 41 in the axial direction and configured to form inclined faces serving as the end faces of the stator core 25 in the axial direction. In this case, it is possible to advantageously construct the stator core 25 having a desired shape in the axial direction using the laminated core part 41 having the same configuration as those of the prior art.

By forming the inclined core parts 42 with magnetic powder, the stator core 25 can be easily realized even when the stator core 25 should be configured to have inclined end faces in the axial direction. The inclined core parts 42 formed of magnetic powder are inferior to electromagnetic steel plates in terms of saturation magnetic flux density, but by combining them with the laminated core part 41, it is possible to achieve an appropriate saturation magnetic flux density.

A known rotating electric machine 10 is configured to fix the stator core 25 by engaging the yoke 26 with the housing 14. In this case, when the inclined core parts 42 formed of a magnetic powder compact are provided on the axial end faces of the stator core 25, there may be disadvantages such as breakage of the inclined core parts 42 upon fixing of the core. Regarding this, in the above-described configuration, since the inclined core part 42 is provided over an area of the axial end face of the stator core 25 excluding at least a part of the yoke 26 (for example, the engaging part with the housing 14), the stator core 25 can be appropriately fixed even though the inclined core part 42 is provided on the core end face.

At the coil end parts 36 and 37, the connection parts (the turn parts 33 and the twisted parts 34) located at the radially inner side of the slots 24 are configured to raise more than the connection parts located at the radially outer side of the slots 24. In this case, the inclined faces of the axial end faces of the stator core 25 are oriented in the same direction as the raisings of the coil end parts 36 and 37, and thus efficient space utilization is possible at the axial end faces of the stator core 25. That is, the allowable space granted to the rotating electric machine 10 can be utilized with maximum efficiency.

### Second Embodiment

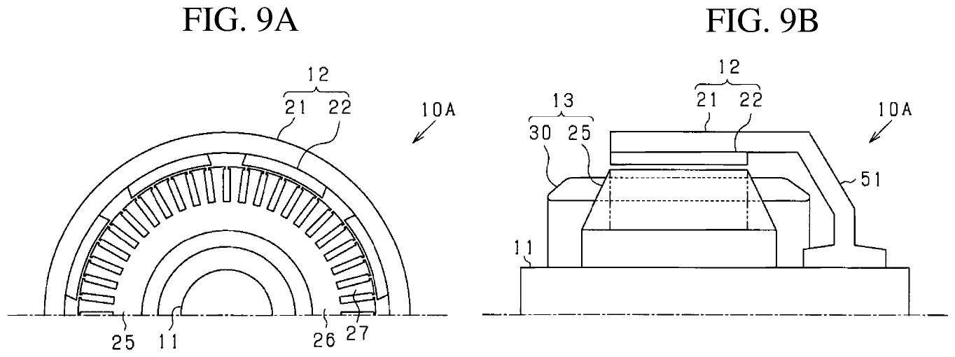

A multiphase AC motor of the outer rotor type (external rotation type) may be adopted as the rotating electric machine. The rotating electric machine 10A of the present embodiment will be described with reference to FIGS. 9A and 9B. The rotating electric machine 10A of this embodiment is different from the rotating electric machine 10 of the first embodiment in that the inner and outer positions of the rotor 12 and the stator 13 are interchanged, but the basic configuration is the same. The second embodiment will now be explained focusing on its differences from the first embodiment.

The rotor 12 of the rotating electric machine 10A comprises an annular rotor core 21, and permanent magnets 22 are provided on the inner periphery of the rotor core 21. The rotor core 21 is fixed to the rotation shaft 11 by an arm 51. The stator 13 is located on the inner side of the rotor 12 (permanent magnets 22). The stator core 25 comprises teeth 27 extending radially outward from an annular yoke 26 toward the rotor 12.

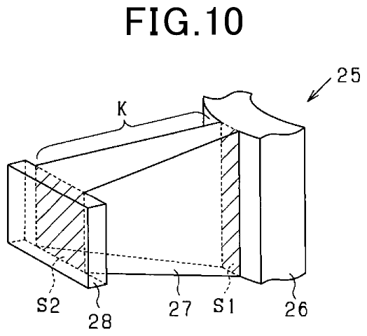

In such basic configuration, the teeth 27 are configured such that their width in the peripheral direction becomes narrower and their thickness in the axial direction becomes thicker toward the radially inner side from the radially outer side. In the rotating electrical machine 10A, the rotor core 21 is placed outside the stator 13, and the teeth 27 are configured such that the width in the peripheral direction becomes wider and the thickness in the axial direction becomes thinner toward the radially outer side. As shown in FIG. 10, the part of the tooth 27 excluding the flange 28 is the partition part K partitioning the slots 24 in the peripheral direction, and the cross-sectional area S1 of the inner peripheral side end of the partition part K and the cross-sectional area S2 of the outer peripheral side end thereof are the same (S1=S2).

The peripheral width of the teeth 27 increases toward the radially outer side, which is the rotor 12 side, but since the axial thickness decreases correspondingly, it is possible to prevent excessive increase in the area of the magnetic flux path at the outer peripheral part of the teeth 27. In this case, as with the case described earlier, there is no need to change the manner of accommodating the conductor in the slots 24 between the inner peripheral side and the outer peripheral side, and magnetic saturation at the teeth 27 can be alleviated without increasing the device size.

### Third Embodiment

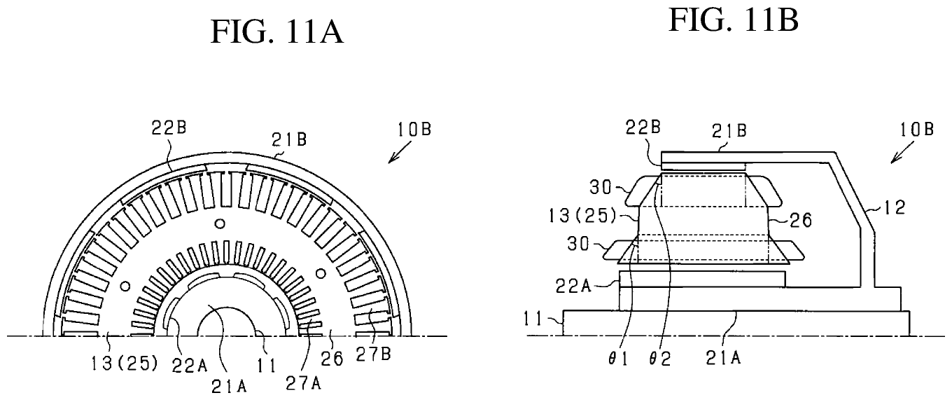

A multiphase AC motor of the double rotor type (composite internal/external rotation type) may be adopted as the rotating electric machine. The rotating electric machine 10B of the present embodiment will be described with reference to FIGS. 11A and 11B. The rotating electric machine 10B of the present embodiment is different from the rotating electric machine 10 of the first embodiment in that the magnetic pole parts of the rotor 12 are placed on the inner side and the outer side of the stator 13. The third embodiment will now be explained focusing on its differences from the first embodiment.

The rotor 12 of the rotating electric machine 10B comprises a first rotor core 21A placed on the inner peripheral side of the stator 13 and a second rotor core 21B placed on the outer peripheral side of the stator 13. First magnetic pole parts 22A and second magnetic pole parts 22B are provided on the first rotor core 21A and the second rotor core 21B, respectively, as the magnetic pole parts. Each of the magnetic pole parts 22A and 22B is made of a permanent magnet. The stator core 25 comprises, as the teeth, first teeth 27A extending radially inward from the yoke 26 toward the first magnetic pole parts 22A, and second teeth 27B extending radially outward from the yoke 26 toward the second magnetic pole parts 22B. The first teeth 27A and the second teeth 27B are configured such that their width in the peripheral direction becomes narrower and their thickness in the axial direction becomes thicker toward the radially inner side from the radially outer side.

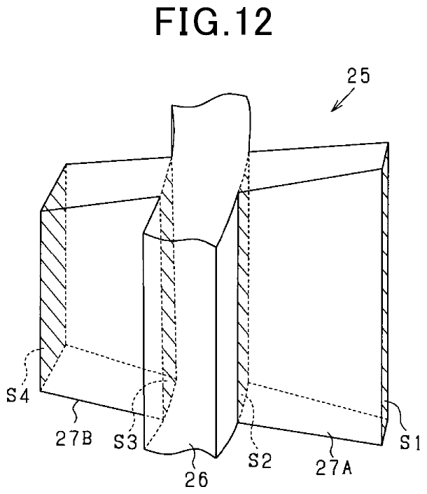

In FIG. 12, the first teeth 27A are configured such that the cross-sectional area S1 of their inner peripheral side end and the cross-sectional area S2 of their outer peripheral side end are the same (S1=S2), and the second teeth 27B are configured such that the cross-sectional area S3 of their inner peripheral side end and the cross-sectional area S4 of their outer peripheral side end are the same (S3=S4). In the configuration of FIG. 12, it is further preferable that S2=S3. Note that, in FIG. 12, the flange 28 at the tip of each tooth 27A, 27B is omitted.

According to the present embodiment, in the rotating electric machine 10B of the double rotor type, as with the cases described earlier, there is no need to change the manner of accommodating the conductor in the slots 24 between the inner peripheral side and the outer peripheral side, and magnetic saturation at the teeth 27A, 27B can be alleviated without increasing the device size.

Here, the end faces of the parts corresponding to the first teeth 27A and the second teeth 27B are inclined faces inclined with respect to the direction orthogonal to the axial direction, and the inclination angles of the inclined faces are the same on the first teeth 27A side and the second teeth 27B side. However, the inclination angles of the inclined faces may be different between the first teeth 27A side and the second teeth 27B side. That is, in FIG. 11B, θ1=θ2 or θ1≠θ2.

When the inclination angles θ1 and θ2 of the inclined faces are different between the first teeth 27A side and the second teeth 27B side, the inclination angles θ1 and θ2 may be individually determined according to the radial length and peripheral width of the teeth 27A and 27B. However, in either case, the inclination angles θ1 and θ2 should be determined so that, for both of the teeth 27A and teeth 27B, the cross-sectional area of the inner peripheral side end is equal to the cross-sectional area of the outer peripheral side end, respectively. In the configuration in which the inclination angles θ1 and θ2 of the inclined faces (the end faces of the stator core 25 in the axial direction) differ between the first teeth 27A side and the second teeth 27B side, it is possible to make the cross-sectional areas of the teeth on the inner peripheral side and the outer peripheral side of the slots 24 the same even if the radial lengths or the peripheral widths of the first teeth 27A and the second teeth 27B differ from each other.

### Fourth Embodiment

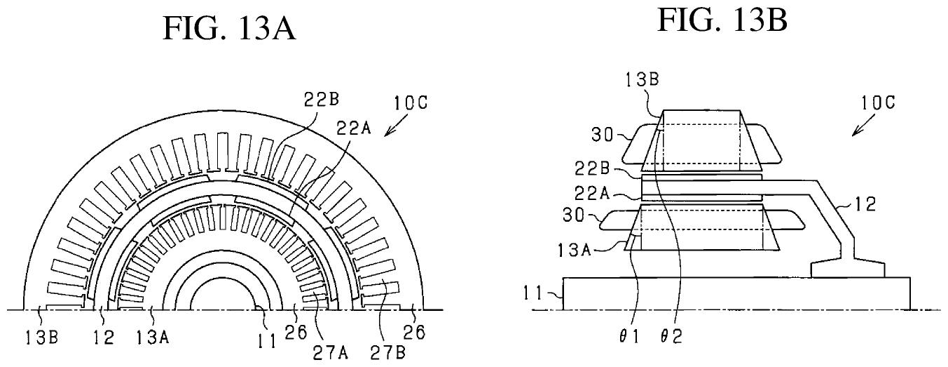

A multiphase AC motor of the double stator type (composite internal/external rotation type) may be adopted as the rotating electric machine. The rotating electric machine 10C of the present embodiment will be described with reference to FIGS. 13A and 13B. The rotating electric machine 10C of the present embodiment is different from the rotating electric machine 10 of the first embodiment in that stators 13 are provided on both of the inner side and the outer side so as to sandwich the rotor 12. The fourth embodiment will now be explained focusing on its differences from the first embodiment.

The rotating electric machine 10C includes, as the stators, a first stator 13A and a second stator 13B placed on the radially inner side and the radially outer side, respectively, with a gap between them. The rotor 12 provided between the first stator 13A and the second stator 13B comprises, as the magnetic pole parts, first magnetic pole parts 22A disposed on the inner peripheral side, and second magnetic pole parts 22B disposed on the outer peripheral side. One of the stator cores 25 provided respectively in the first stator 13A and the second stator 13B comprises, as the teeth, first teeth 27A extending radially outward from the yoke 26 toward the first magnetic pole parts 22A, and second teeth 27B extending radially inward from the yoke 26 toward the second magnetic pole parts 22B. The first teeth 27A and second teeth 27B are configured such that their width in the peripheral direction becomes narrower and their thickness in the axial direction becomes thicker toward the radially inner side from the radially outer side.

According to the present embodiment, in the rotating electric machine 10C of the double stator type, as with the cases described earlier, there is no need to change the manner of accommodating the conductor in the slots 24 between the inner peripheral side and the outer peripheral side, and magnetic saturation at the teeth 27A, 27B can be alleviated without increasing the device size.

In the rotating electric machine 10C, the inclination angles of the inclined faces are the same between the first teeth 27A side and the second teeth 27B side (θ1=θ2). However, the inclination angles of the inclined faces may be different between the first teeth 27A side and the second teeth 27B side (θ1≠θ2).

### Other Embodiments

The above-described embodiments may be modified, for example, as follows.

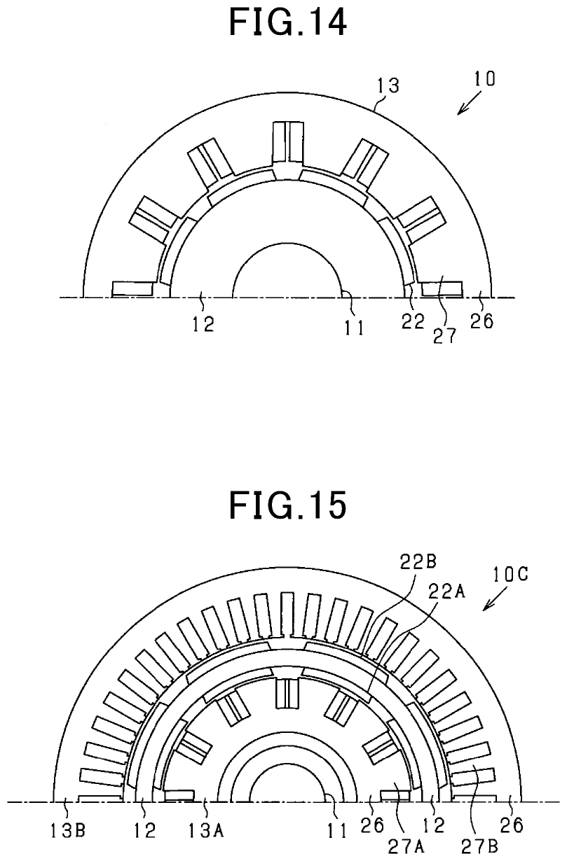

Other than the above-described embodiments, the present invention may also be applied to the rotating electric machines 10 of the following configurations. FIG. 14 shows the configuration of a rotating electric machine 10 of the inner rotor type. The rotating electric machine 10 of FIG. 14 has a configuration of concentrated winding with 8 poles and 12 slots. It is also preferable in this configuration that the teeth 27 are configured such that their width in the peripheral direction becomes narrower and their thickness in the axial direction becomes thicker toward the radially inner side from the radially outer side.

FIG. 15 shows the configuration of a rotating electric machine 10C of the double stator type. In the rotating electric machine 10C of FIG. 15, the rotor 12 has eight poles both inside and outside. The first stator 13A on the inner side of the rotor 12 has 12 teeth, and the stator winding 30 is wound by concentrated winding. The second stator 13B on the outer side of the rotor 12 has 48 teeth, and the stator winding 30 is wound by full-pitch distributed winding. The number of the first teeth 27A on the radially inner side is smaller than the number of the second teeth 27B on the radially outer side.

In the rotating electric machine 10C of FIG. 15, since the number of the first teeth 27A and the number of second teeth 27B are different, it is possible to adopt different winding schemes of the stator winding 30 for the radially inner side (first teeth 27A side) and the radially outer side (second teeth 27B side). The rotating electric machine 10B of the double rotor type may also be configured such that the number of the first teeth 27A is different from the number of the second teeth 27B.

In a rotating electric machine of the composite internal/external type, the number of magnetic poles may be different between the magnetic pole parts of the radially inner side and the magnetic pole parts on the radially outer side. In addition, the scheme of the stator winding 30 may be different between the radially inner side and the outer side. For example, it is conceivable to adopt six-pole concentrated winding for the radially inner side and eight-pole full-pitch distributed winding for the radially outer side.

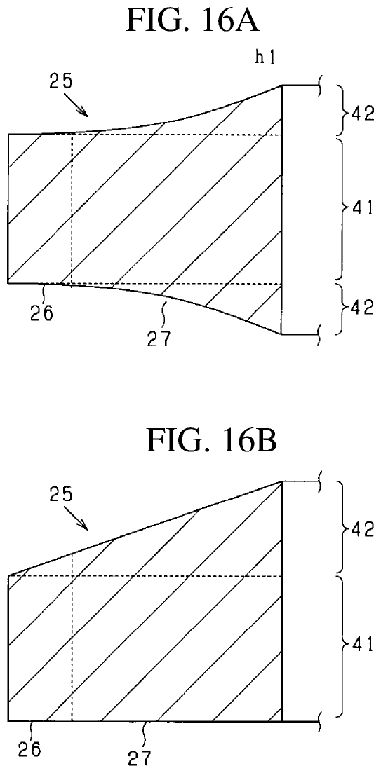

In the above-described embodiments, the stator core 25 is configured such that the inclined faces of the core end faces extend linearly in the radial direction (see FIG. 6B). However, this may be changed. FIG. 16A shows an axial cross section of a tooth 27. Note that the peripheral side face of the tooth 27 is a straight flat face (see FIG. 6A). In FIG. 16A, the end faces of the stator core 25 in the axial direction are inclined with respect to the direction orthogonal to the axial direction, and they form inclined faces which gradually bulge outward in the axial direction toward the radially inner side. Further, the inclined faces are arc faces extending in a concave shape in the radial direction.

In the above configuration, since the inclined faces are arc faces extending in a concave shape in the radial direction, as compared with the configuration in which the inclined faces extend linearly in the radial direction (the configuration with a conical shape), it is possible to reduce the difference in the cross-sectional area of the tooth at each part in the radial direction. That is, when the area S of the radial cross section of the teeth 27 is represented as “peripheral width D×(multiplied by) axial thickness H”, by making the peripheral width D change proportionally in the radial direction and the axial thickness H change in an inverse proportional manner, it is possible to make the cross-sectional area of each tooth generally the same at each part in the radial direction. As a result, the amount of magnetic flux can be made uniform in the radial direction of the teeth 27.

In the stator core 25 shown in FIG. 16B, only one of its two ends in the axial direction is inclined. That is, one of the two axial ends of the stator core 25 is an inclined face inclined with respect to the direction orthogonal to the axial direction, and the other is a flat face extending in the direction orthogonal to the axial direction. In this case, a configuration in which the one of the two axial faces of the stator core 25 that is on the first coil end part 36 side (the side of the turn parts 33 of the conductor segments 31) is an inclined face and the other face on the second coil end part 37 side (twisted part 34 side) is a flat face, or a configuration in which the face on the first coil end part 36 side is a flat face and the other face on the second coil end part 37 side is an inclined face can be considered. However, considering the ease of assembly of the conductor segments 31, it may be preferable that the one of the two axial faces of the stator core 25 that is on the first coil end part 36 side is an inclined face and the other face on the second coil end part 37 side is a flat face. If the conductor segments 31 are joined with each other on the flat face side of the two axial faces of the stator core 25, it is possible to facilitate the twisting process for the joining as well as the joining process.

The configurations of FIGS. 16A and 16B can also be applied to rotating electric machines of any of the inner rotor type, the outer rotor type, the double rotor type, and the double stator type.

In the above-described embodiments, the stator core 25 comprises the laminated core part 41 formed by laminating steel plates 41a and the inclined core parts 42 formed of magnetic powder, but this configuration may be changed. For example, the whole of the stator core 25, that is, the whole of it including the inclined parts (the umbrella parts) may be formed of magnetic powder.

The rotating electric machine to which the present invention is applied may be an induction motor with a squirrel-cage conductor. In addition, it may also be applied to rotating electric machines of the claw pole winding field type, the salient pole reluctance type, and the magnetic modulation reluctance type.

Although the present disclosure is described based on examples, it should be understood that the present disclosure is not limited to the examples and structures. The present disclosure encompasses various modifications and variations within the scope of equivalence. In addition, the scope of the present disclosure and the spirit include other combinations and embodiments, only one component thereof, and other combinations and embodiments that are more than that or less than that.

What is claimed is:

1. A rotating electric machine comprising:
a rotor having a plurality of magnetic pole parts in a peripheral direction, and
at least one stator arranged coaxially with the rotor and on at least one of an outer peripheral side and an inner peripheral side of the magnetic pole parts, wherein
the stator includes a stator core having a plurality of slots in the peripheral direction, and a stator winding wound around the slots,
the stator core includes an annular yoke and a plurality of teeth extending in a radial direction from the yoke toward the magnetic pole parts,
the stator winding has a configuration in which a plurality of conductors in the slots separated by one magnetic pole are connected by connection parts, and
the teeth are configured such that their width in the peripheral direction becomes narrower and their thickness in an axial direction becomes thicker toward a radially inner side from a radially outer side.

2. The rotating electric machine according to claim 1, wherein
at at least one of two axial ends of the stator core, an end face of a part corresponding to the teeth is inclined with respect to a direction orthogonal to the axial direction, and forms an inclined face that gradually bulges outward in the axial direction toward the radially inner side.

3. The rotating electric machine according to claim 1, wherein
each of the teeth is configured such that, at a partition part thereof partitioning the slots in the peripheral direction, a cross-sectional area of an inner peripheral side end and a cross-sectional area of an outer peripheral side end are the same.

4. The rotating electric machine according to claim 1, wherein
a peripheral side face of the teeth is a straight flat face, and, at at least one of two axial ends of the stator core, an end face of a part corresponding to the teeth is inclined with respect to a direction orthogonal to the axial direction, and forms an inclined face that gradually bulges outward in the axial direction toward the radially inner side, and
the inclined face is an arc face extending in a concave shape in the radial direction.

5. The rotating electric machine according to claim 1, wherein
the stator core comprises a laminated core part formed by laminating a plurality of steel plates, and at least one inclined core part integrally provided on at least one of two axial ends of the laminated core part and configured to convert an axial end face of the stator core to an inclined face inclined with respect to a direction orthogonal to the axial direction and gradually bulging outward in the axial direction toward the radially inner side.

6. The rotating electric machine according to claim 5, wherein
the inclined core part is formed of a compact of magnetic powder.

7. The rotating electric machine according to claim 6, wherein
the inclined core part is provided over an area of the axial end face of the stator core excluding at least a part of the yoke.

8. The rotating electric machine according to claim 1, wherein
the conductors forming the stator winding are arranged in the radial direction in the slots,
at both axial ends of the stator core, the connection parts form coil end parts, each of the connection parts being a part of the stator winding connecting the stator winding between the slots separated by at least a distance of one magnetic pole,
at at least one of the two axial ends of the stator core, an end face of a part corresponding to the teeth is inclined with respect to a direction orthogonal to the axial direction, and forms an inclined face that gradually bulges outward in the axial direction toward the radially inner side, and
at the coil end parts, the connection parts located on the radially inner side of the slots form a shape that is more raised than the connection parts located on the radially outer side of the slots.

9. The rotating electric machine according to claim 1, wherein
the rotor includes, as the magnetic pole parts, first magnetic pole parts disposed on the inner peripheral side of the stator, and second magnetic pole parts disposed on the outer peripheral side of the stator,
the stator core includes, as the teeth, first teeth extending radially inward from the yoke toward the first magnetic pole parts, and second teeth extending radially outward from the yoke toward the second magnetic pole parts, and
the first teeth and the second teeth are configured such that their width in the peripheral direction becomes narrower and their thickness in the axial direction becomes thicker toward the radially inner side from the radially outer side.

10. The rotating electric machine according to claim 1, wherein
the rotating electric machine comprises, as the stator, a first stator and a second stator placed on the radially inner side and the radially outer side, respectively, with a gap between them,
the rotor provided between the first stator and the second stator comprises, as the magnetic pole parts, first magnetic pole parts disposed on the inner peripheral side, and second magnetic pole parts disposed on the outer peripheral side,
one of the stator cores provided respectively in the first stator and the second stator comprises, as the teeth, first teeth extending radially outward from the yoke toward the first magnetic pole parts, and second teeth extending radially inward from the yoke toward the second magnetic pole parts, and
the first teeth and the second teeth are configured such that their width in the peripheral direction becomes narrower and their thickness in the axial direction becomes thicker toward the radially inner side from the radially outer side.

11. The rotating electric machine according to claim 9, wherein
at at least one of two ends of the stator in the axial direction, end faces of parts corresponding to the first teeth and the second teeth are inclined faces inclined with respect to a direction orthogonal to the axial direction, and
inclination angles of the inclined faces are different between a first teeth side and a second teeth side.

12. The rotating electric machine according to claim 9, wherein
the number of the first teeth is different from the number of the second teeth.
